(19) United States
(12) Patent Application Publication
(10) Pub. No.: US 2011/0014463 A1
(43) Pub. Date: Jan. 20, 2011

(54) REMOVABLE ADHESIVE SHEET

(75) Inventors: Shigeyuki Yaguchi, Tokyo (JP); Yoshitomo Ono, Tokyo (JP)

Correspondence Address: HOLTZ, HOLTZ, GOODMAN & CHICK PC, 220 Fifth Avenue, 16TH Floor, NEW YORK, NY, 10001-7708, US

(73) Assignees: LINTEC Corporation, Tokyo (JP); Honda Giken Kogyo Kabushiki Kaisha, Tokyo (JP)

(21) Appl. No.: 12/934,309

(22) PCT Filed: Mar. 25, 2009
(86) PCT No.: PCT/JP2009/056765

§ 371 Date: Sep. 24, 2010

(30) Foreign Application Priority Data
Mar. 27, 2008 (JP) 2008-083528

(51) Int. Cl. C09J 7/02; H01F 1/04; H01F 1/26

(52) U.S. Cl. 428/343; 252/62.55; 252/62.54

(57) ABSTRACT

The present invention provides a removable adhesive sheet, which comprises a mixture of a hot-melt removable adhesive and a ferromagnetic material. The removable adhesive sheet of the present invention can be held to the prescribed location by means of magnetic force in initial stage of the adhesion at room temperature to an article composed of a metal or the like, and further, can move easily and position easily to a correct location, and can be peeled off easily after sticking by heating.

### TECHNICAL FIELD

The present invention relates to a removable adhesive sheet. Specifically, the present invention relates to the removable adhesive sheet which can also be applied to fields where solvent resistance and chemical resistance are required.

### BACKGROUND ART

Conventionally, with respect to an adhesive sheet, there have been problems that if the adhesive sheet is positioned incorrectly to the location to be stuck in the initial stage of the adhesion to an article, it is difficult to peel off from the incorrect location and stick to the correct location, or even if the peeling off and the sticking can be conducted, the adhesive residue is remained on the surface of the article. In addition, there has been a problem that when an adhesive sheet having a large area is stuck on an article, the workability is remarkably inferior, or it is difficult to stick the adhesive sheet on a surface of an article smeared with oil on the surface.

In order to solve the problems, as a method for reinforcing a thin steel plate or the like used in doors of automobiles, a method for reinforcing a steel plate which comprises attaching a reinforcing sheet comprising a mixture of a rubber based synthetic resin, a magnetic powder and a foaming agent, to a prescribed location of the thin steel plate by means of magnetic force and holding temporarily, and then fusion bonding by heating, has been proposed (see JP2006-315234 A1).

However, the method is too strong in adhesion to the thin steel plate, because the method is a method for fusion adhering a rubber based synthetic resin to a thin steel plate by heating. Therefore, there have been a problem that it is difficult to peel off the reinforcing sheet beautifully, when the reinforcing sheet is tried to peel off after fusion adhering by heating, and also, a problem that it is inferior in solvent resistance or chemical resistance because of the rubber based synthetic resin.

Further, it has been conducted to protect a rail surface of a slide rail on an automobile door with a masking pressure-sensitive adhesive tape and then, coat a surface except for the rail surface. However, the masking pressure-sensitive adhesive tape has a tack, and therefore, the masking pressure-sensitive adhesive tape has been needed to cover the surface of pressure-sensitive adhesive with a release paper. And, when the adhesive sheet is positioned incorrectly location, it is difficult to peel off from the incorrect location and stick to the correct location. Furthermore, when the adhesive sheet is used, the operation for peeling off and removing the release paper and the operation for throwing away the removed release paper have been also needed.

### DISCLOSURE OF THE INVENTION

The present invention is provided as the result of considering the situation of the conventional technologies described above.

An object of the present invention is to provide a removable adhesive sheet which can be held to the prescribed location by means of magnetic force and does not almost have a tack in initial stage of the adhesion at room temperature (ordinary temperature) to an article composed of a metal or the like, and therefore, can move easily and position easily to a correct location even if the positioning of the location to be stuck is incorrect, and does not cause the adhesive residue on the surface of the article, can increase the workability remarkably when the adhesive sheet having a large area is stuck, and further, can be peeled off easily after sticking by heating.

The present inventors have perfected the present invention by discovering a removable adhesive sheet comprises a mixture of a hot-melt removable adhesive and a ferromagnetic material, and the above-described problems can be solved by thereof.

That is to say, the present invention provides a removable adhesive sheet, which comprises a mixture of a hot-melt removable adhesive and a ferromagnetic material.

Additionally, the present invention provides the removable adhesive sheet as described above, wherein the mixture has a viscosity of 5 to 500 Pa·s at 130° C.

Additionally, the present invention provides the removable adhesive sheet as described above, wherein the hot-melt removable adhesive is a polyolefin resin based hot-melt removable adhesive.

Further, the present invention provides the removable adhesive sheet as described above, wherein a surface magnetic force is not less than 20 mT and a surface magnetic force after heating (at 150° C. for 40 minutes) is less than 5 mT.

Furthermore, the present invention provides the removable adhesive sheet as described above, wherein the removable adhesive sheet is used for masking an article exhibiting ferromagnetism.

Furthermore, the present invention provides the removable adhesive sheet as described above, wherein the removable adhesive sheet is a masking tape for a slide rail of an automobile.

Furthermore, the present invention provides a removable adhesive sheet with a substrate which comprises the removable adhesive sheet as described above and a substrate, wherein the removable adhesive sheet is laminated on one surface or both surfaces of the substrate.

The removable adhesive sheet of the present invention can be held to the prescribed location by means of magnetic force and does not almost have a tack in initial stage of the adhesion at room temperature to an article composed of a metal or the like, and therefore, can move easily and position easily to a correct location even if the positioning of the location to be stuck is incorrect, and does not cause the adhesive residue on the surface of the article, can increase the workability remarkably when the adhesive sheet having a large area is stuck, and further, can generate a weak adhesion by heating, and therefore, can be held by means of adhesion on the location to be stuck even if the magnetic force is decreased by heating, and can be peeled off easily when the peeling off is tried, because the adhesion is weak.

### PREFERRED EMBODIMENTS FOR CARRYING OUT THE INVENTION

The removable adhesive sheet of the present invention comprises a mixture of a hot-melt removable adhesive and a ferromagnetic material.

The hot-melt removable adhesive is an adhesive which has no tack or has almost no tack at room temperature (ordinary temperature), but is softened by heating and generates adhesive property, and then is solidified by returning the heated hot-melt adhesive to the room temperature, and can stick to be able to remove thereby.

The hot-melt removable adhesive includes a polyolefin resin based hot-melt removable adhesive and a polyester resin based hot-melt removable adhesive. Among them, the polyolefin resin based hot-melt removable adhesive is preferable.

The word “removable” means a state that the adhesive sheet can be peeled off relatively easily after sticking, and the adhesive residue is not observed on the surface of the article by visual.

Examples of resin ingredient of the polyolefin resin based hot-melt removable adhesive include a propylene-ethylene-butene copolymer and an ethylene-vinyl acetate copolymer.

Commercial product of the polyolefin resin based hot-melt removable adhesive includes “MORESCOMELT EP-70” and “MORESCOMELT EP-725” produced by MORESCO Corporation.

The melting point (fusion temperature) of the hot-melt removable adhesive is preferably in the range of 100 to 200° C., more preferably in the range of 120 to 200° C., and most preferably in the range of 130 to 180° C.

The ferromagnetic material is a substance which can have spontaneous magnetization, even if an external magnetic field does not exist. The ferromagnetic material includes also a ferrimagnetic material. Examples of the ferromagnetic material include iron, cobalt, nickel, ferrite such as barium ferrite and strontium ferrite, rare earth magnetic material such as rare earth cobalt magnet, and Alnico magnet. Among them, ferrite and mixtures thereof are preferable for controlling the initial magnetism finely.

The ferromagnetic material is preferably powder (called by “magnetic powder” hereinafter). The average particle diameter of the magnetic powder is preferably in the range of 0.5 to 20 μm, more preferably in the range of 0.5 to 15 μm, and most preferably in the range of 1 to 5 μm.

The mixing ratio of the magnetic powder is preferably in the range of 100 to 400 parts by mass, more preferably in the range of 120 to 350 parts by mass, and most preferably in the range of 150 to 300 parts by mass to 100 parts by mass of the hot-melt removable adhesive.

For dispersing the magnetic powder in the hot-melt removable adhesive, it is preferable to mix by heating the hot-melt removable adhesive and the magnetic powder.

The heating temperature is preferably in the range of 110 to 230° C., more preferably in the range of 120 to 180° C., most preferably in the range of 130 to 170° C. Also, the heating temperature is preferably 10° C. or more higher than the fusion temperature of the hot-melt removable adhesive, and more preferably 20° C. to 70° C. higher than the fusion temperature of the hot-melt removable adhesive. By mixing at the temperature range, the magnetic powder can be homogeneously dispersed in the hot-melt removable adhesive, and also, it is able to prevent the deterioration of the hot-melt removable adhesive.

In the present invention, the desired properties are exerted in a state that the ferromagnetic material in the adhesive sheet is magnetized. Therefore, the hot-melt removable adhesive and the magnetized magnetic powder can be mixed, or the magnetization can be conducted after the hot-melt adhesive and the magnetic powder are mixed. When the hot-melt removable adhesive and the magnetized magnetic powder are mixed by heating, there is a case that the demagnetization is caused. In this case, the magnetization can be conducted.

In the mixture of the hot-melt removable adhesive and the magnetic powder comprised in the removable adhesive sheet of the present invention, one or more members of a tackifier, an antioxidant, a filler, a dispersing agent or the like can be properly compounded.

The mixture of the hot-melt removable adhesive and the magnetic powder comprised in the removable adhesive sheet of the present invention has preferably a viscosity of 5 to 500 Pa·s, and more preferably a viscosity of 50 to 200 Pa·s at 130° C. When the viscosity is in the range, the state that the ferromagnetic material is dispersed in the hot-melt removable adhesive can be maintained even if the adhesive composition is heated. The measurement of the viscosity is conducted according to the method of JIS K6833, except that the temperature of the sample is 130° C.

The removable adhesive sheet of the present invention is a sheet comprising the mixture of the hot-melt removable adhesive and the ferromagnetic material described above.

The removable adhesive sheet of the present invention has a surface magnetic force at room temperature of preferably not less than 20 mT, and more preferably 25 to 100 mT. Herein, the surface magnetic force means a surface magnetic force measured by a Gaussian meter at a distance which is 1 cm apart from the surface of the removable adhesive sheet of the present invention.

The removable adhesive sheet of the present invention has a surface magnetic force after heating of preferably less than 5 mT, more preferably not more than 3 mT, and most preferably not more than 1.5 mT. The lower limitation value of the surface magnetic force is 0 mT.

Herein, the surface magnetic force after heating means the surface magnetic force measured by a Gaussian meter at a distance which is 1 cm apart from the surface of the removable adhesive sheet, after the removable adhesive sheet is heated at 150° C. for 40 minutes and then, is returned to the room temperature.

Thus, the removable adhesive sheet of the present invention has a strong surface magnetic force at room temperature before heating, and has no tack or has almost no tack at room temperature. Therefore, the removable adhesive sheet of the present invention can be attached to the article composed of metal or the like by means of only the surface magnetic force. Even if the positioning of the location to be attached is incorrect, the removable adhesive sheet of the present invention can move easily and position easily to a correct location. Also, the removable adhesive sheet of the present invention generates weak adhesion by heating, and therefore, can be stuck to the article composed of metal or the like. And, the surface magnetic force can be decreased extremely to be small value when the removable adhesive sheet is heated and then, returned to the room temperature, and therefore, the influence of the magnetic force to the human or electronic equipment can be suppressed as much as possible.

The removable adhesive sheet of the present invention can be produced by a method which comprises heating the mixture of the hot-melt removable adhesive and the magnetic powder to change to fluid state, and applying the fluidized mixture on the surface of a release liner, or a method which comprises extruding the mixture of the hot-melt removable adhesive and the magnetic powder in a sheet form by an extruder. The temperature of the mixture of the hot-melt removable adhesive and the magnetic powder at applying is preferably in the range of 130 to 170° C. The extruding temperature of the mixture of the hot-melt removable adhesive and the magnetic powder is preferably in the range of 130 to 170° C.

As the release liner, a release liner provided with the releasing treatment on both surfaces, a release liner provided with the releasing treatment on one surface and the like can be used.

The release liner includes, for example, release liners obtained by applying a release agent such as silicone resin on paper materials such as a glassine paper, a coated paper and a wood free paper, a laminated paper which is laminated with a thermoplastic resin such as polyethylene on the paper material thereof, or a plastic film such as films of polyester resin like polyethylene terephthalate resin, polybutylene terephthalate resin and polyethylene naphthalate resin; or films of polyolefin resin such as polypropylene resin and polyethylene resin.

No particular constraint is imposed on the thickness of the release liner; however, usually the thickness falls preferably within a range from 20 to 200 μm.

The removable adhesive sheet of the present invention can be also a removable adhesive sheet with a substrate which comprises a substrate sheet and a removable adhesive sheet comprising the mixture of the hot-melt removable adhesive and the magnetic powder, wherein the removable adhesive sheet is laminated on one surface or both surfaces of the substrate sheet.

Examples of the substrate sheet include, for example, sheets or films of various synthetic resins of polyolefin resins such as polyethylene resin and polypropylene resin; polyester resins such as polyethylene terephthalate resin, polyethylene naphthalate resin and polybutylene terephthalate resin; polyvinyl chloride resins; polystyrene resins; polyurethane resins; polycarbonate resins; polyamide resins; polyimide resins; fluorine resins and the like. In view of high strength and cheap cost, sheets or films of polyester resins such as polyethylene terephthalate resin are preferable. The substrate sheet can be a single layer or a multiple layers having two or more layers of the same type or different types.

No particular constraint is imposed on the thickness of the substrate sheet; however, usually the thickness falls preferably within a range from 10 to 350 μm, more preferably within a range from 25 to 300 μm, and most preferably within a range from 50 to 250 μm.

On the surface of the substrate sheet, a treatment for improving adhesion can be provided. The treatment for improving adhesion is not limited particularly, but includes, for example, corona discharge treatment.

No particular constraint is imposed on the thickness of the removable adhesive sheet comprising the mixture of the hot-melt removable adhesive and the magnetic powder; however, usually the thickness falls preferably within a range from 3 to 150 μm, more preferably within a range from 5 to 100 μm, most preferably within a range from 10 to 60 μm.

The removable adhesive sheet laminating the removable adhesive sheet comprising the mixture of the hot-melt removable adhesive and the magnetic powder described above on one surface or both surfaces of the substrate sheet, can be produced by a method which comprises applying the heated mixture of the hot-melt removable adhesive and the magnetic powder described above on one surface or both surfaces of the substrate sheet, or a method which comprises extruding the heated mixture of the hot-melt removable adhesive and the magnetic powder described above in a sheet form by an extruder, and then, laminating the extruded sheet on one surface or both surfaces of the substrate sheet. The temperature of the mixture of the hot-melt removable adhesive and the magnetic powder at applying is preferably in the range of 130 to 170° C. The extruding temperature of the mixture of the hot-melt removable adhesive and the magnetic powder is preferably in the range of 130 to 170° C.

In addition, the removable adhesive sheet with a substrate can be produced by forming the layer comprising the mixture of the hot-melt removable adhesive and the magnetic powder on the surface of the release liner described above, and then, laminating the substrate sheet on the surface thereof.

When the layer comprising the mixture of the hot-melt removable adhesive and the magnetic powder described above is formed on one surface of the substrate sheet in the removable adhesive sheet of the present invention, a pressure-sensitive adhesive layer can be formed on the other surface of the substrate sheet.

The pressure-sensitive adhesive has a tack at room temperature and includes, for example, natural rubber-based pressure-sensitive adhesives, synthetic rubber-based pressure-sensitive adhesives, acrylic resin-based pressure-sensitive adhesives, polyvinylether resin-based pressure-sensitive adhesives, urethane resin-based pressure-sensitive adhesives and silicone resin-based pressure-sensitive adhesives.

No particular constraint is imposed on the thickness of the pressure-sensitive adhesive layer; however, usually the thickness after drying falls preferably within a range from 3 to 150 μm, more preferably within a range from 5 to 100 μm and particularly preferably within a range from 10 to 60 μm.

The formation of pressure-sensitive adhesive layer on the other surface of the substrate sheet can be conducted by applying the pressure-sensitive adhesive described above on the other surface of the substrate sheet, and optionally drying.

Application methods of the pressure-sensitive adhesive composition described above on the substrate sheet include conventional known methods such as, for example, a bar coating method, a knife coating method, a roll coating method, a blade coating method, a die coating method, a gravure coating method and a curtain coating method.

The drying is preferable to carry out usually at 20 to 50° C.

The removable adhesive sheet of the present invention can be stuck temporarily to the article, and then peeled off and removed from the article, and therefore, can be used preferably, for example, as an adhesive sheet for masking an article exhibiting ferromagnetic property.

The article exhibiting ferromagnetic property includes iron and nickel.

When a treatment such as coating is not provided to the predetermined portion, but a treatment such as coating is provided only to the peripheral portion around the predetermined portion, the adhesive sheet for masking an article is stuck to the predetermined portion, the treatment such as coating is provided to the peripheral portion, and then, the adhesive sheet for masking an article is peeled off.

Example of the adhesive sheet for masking an article includes a masking adhesive sheet for a slide rail of an automobile door. If the coated film is attached on the rail surface of the slide rail (usually, being made of iron) of an automobile door, the coated film is peeled off by a roll which rolls on the rail surface at opening or shutting the door of the completed automobile. Further, the peeled coated film is attached to the outside of the door, and entered into the room of the automobile. These troubles are not preferable in view of looking or environment. For preventing the troubles, a method which comprises attaching the removable adhesive sheet of the present invention on the rail surface of the slide rail by means of magnetic force before coating the peripheral portion of the slide rail of the automobile door, next heating to generate weak adhesion, further sticking with weak adhesion generated by the heating, subsequently coating the peripheral portion of the slide rail and curing, and then, peeling off the removable adhesive sheet, can be used.

The removable adhesive sheet of the present invention has magnetic force at room temperature before heating, and therefore, can be used for applying to various articles which can be held by means of magnetic force. The removable adhesive sheet of the present invention is preferably heated after holding on the article by means of magnetic force, and cooled after heating. The heating temperature is preferably in the range of 110 to 200 t, more preferably in the range of 120 to 180° C., and most preferably in the range of 130 to 170° C.

The adhesion after heating (at 150° C. for 10 minutes) to the surface of the stainless steel plate of the removable adhesive sheet of the present invention is preferably 10 to 25 N/25 mm, and more preferably 12 to 20 N/25 mm. Further, the adhesion to the surface smeared with oil of a stainless steel plate smeared with oil on the surface is preferably 10 to 22 N/25 mm, and more preferably 12 to 20 N/25 mm.

### EXAMPLES

Hereinafter, specific description will be made on the present invention with reference to Examples. However, the present invention is not limited at all by these Examples.

### Example 1

### (1) Preparation of a Removable Adhesive Mixture

Into a mixing machine (manufactured by PRIMIX Corporation, trade name “T.K. HYBISMIX 2P-1”), 200 parts by mass of strontium ferrite powder (having an average particle diameter of 2 μm) as magnetic powder, and 100 parts by mass of polyolefin resin based hot-melt removable adhesive (manufactured by MORESCO Corporation, trade name “MORESCOMELT EP-70”, fusion temperature of 140° C.) were charged to mix. And then, the mixture was heated at 160 V, and mixed for 30 minutes to obtain a removable adhesive mixture.

### (2) Production of a Removable Adhesive Sheet with a Substrate

The removable adhesive mixture prepared in (1) described above was extruded from a die at an extruding temperature of 160° C., by an extruder to form a removable adhesive layer having a thickness of 250 μm, and the extruded adhesive layer was laminated on a surface of a release liner of a polyethylene terephthalate resin sheet in which a surface was treated with silicone (manufactured by LINTEC Corporation, trade name “SP-PET 100(T)”, thickness of 100 μm). Immediately after the lamination, a substrate sheet (a polyethylene terephthalate sheet produced by TORAY INDUSTRIES, INC., trade name “LUMIRROR #100T60”, having a thickness of 100 μm) was laminated on the surface of the removable adhesive layer, and the adhesive layer was cooled to room temperature. Next, by using a high tension condenser magnetizing and demagnetizing electric power unit (manufactured by MAGNETICLABO Co., Ltd., trade name “PC-2520ND”), the magnetization was conducted under the condition of voltage of 500 V and electric current of 8 kA to form a removable adhesive sheet with a substrate.

By using the obtained removable adhesive sheet with a substrate, the following evaluating tests were conducted. The results are shown in Table 1. The adhesive sheet with a substrate could be peeled off easily after heating, and could decrease the surface magnetic force to small amount by heating.

### Measurement of Viscosity of the Removable Adhesive Mixture

The viscosity of the removable adhesive mixture was measured according to JIS K6833, except that the temperature of the removable adhesive mixture was 130° C.

### Magnetic Force

From the obtained removable adhesive sheet, the release liner was removed, and a magnetic force (mT) at room temperature before heating was measured by a Gaussian meter (manufactured by TOYO Corporation., trade name “5080 type HANDY GAUS METER”) at a distance which is 1 cm apart from the surface of the adhesive layer. In addition, the obtained removable adhesive sheet was heated at 150 V, for 40 minutes and then returned to the room temperature. The magnetic force (mT) at room temperature after heating was measured by a Gaussian meter at a distance which is 1 cm apart from the surface of the adhesive layer.

### Adhesion

The obtained removable adhesive sheet was held (attached) on a stainless steel plate at room temperature. After 20 minutes from the holding (i), the held removable adhesive sheet was heated at 150° C. for 10 minutes, and then, returned to room temperature (ii). And then, the each adhesions were measured according to JIS 20237.

Also, the obtained removable adhesive sheet was held (attached) at room temperature on a surface of a stainless steel plate smeared with oil (manufactured by TOYOTA MOTER CORPORATION, trade name “TOYOTA JUNSEI BLAKEFLUID 2500H”) on the surface. The held removable adhesive sheet was heated at 150° C. for 10 minutes, and then, returned to room temperature. And then, the adhesions were measured according to JIS 20237.

### Solvent Resistance

Ten g of the removable adhesive sheet was immersed into 100 g of toluene for 30 minutes. And then, the existence or non-existence of elution of the removable adhesive sheet into toluene was observed by visual, and the solvent resistance was evaluated according to the following standard.

◯: non-existence of elution
X: existence of elution

### Gasoline Resistance

Ten g of the removable adhesive sheet was immersed into 100 g of gasoline for 30 minutes. And then, the existence or non-existence of elution of the removable adhesive sheet into gasoline was observed by visual, and the resistance was evaluated according to the following standard.

◯: non-existence of elution
X: existence of elution

### Example 2

### (1) Preparation of a Removable Adhesive Mixture

Into a mixing machine (manufactured by PRIMIX Corporation, trade name “T.K. HYBISMIX 2P-1”), 200 parts by mass of strontium ferrite powder (having an average particle diameter of 2 μm) as magnetic powder, and 100 parts by mass of polyolefin resin based hot-melt adhesive (manufactured by MORESCO Corporation, trade name “MORESCOMELT EP-725”, fusion temperature of 140° C.) were charged to mix. And then, the mixture was heated at 160° C., and mixed for 30 minutes to obtain a removable adhesive mixture.

### (2) Production of a Removable Adhesive Sheet

The removable adhesive mixture prepared in (1) described above was extruded from a die at an extruding temperature of 160° C. by an extruder to form a removable adhesive layer having a thickness of 250 μm, and the extruded removable adhesive layer was laminated on a surface of a release liner of a polyethylene terephthalate resin sheet in which a surface was treated with silicone (manufactured by LINTEC Corporation, trade name “SP-PET 100(T)”, thickness of 100 μm). Immediately after the lamination, a substrate sheet (a polyethylene terephthalate sheet produced by TORAY INDUSTRIES, INC., trade name “LUMIRROR #100T60”, having a thickness of 100 μm) was laminated on the surface of the removable adhesive layer, and the removable adhesive layer was cooled to room temperature. Next, the magnetization was conducted in the same method described in Example 1 to form a removable adhesive sheet.

By using the obtained removable adhesive sheet, the above described evaluating tests were conducted. The results are shown in Table 1.

### Example 3

A removable adhesive sheet was prepared in the same method as described in Example 1, except that a barium ferrite powder (having an average particle diameter of 2 μm) was used as the magnetic powder.

By using the obtained removable adhesive sheet, the above described evaluating tests were conducted. The results are shown in Table 1.

### Comparative Example 1

Into a mixing machine (manufactured by PRIMIX Corporation, trade name “T.K. HYBISMIX 2P-1”), 200 parts by mass of strontium ferrite powder (having an average particle diameter of 2 μm) as magnetic powder, and 100 parts by mass of rubber based pressure-sensitive adhesive (manufactured by MORESCO Corporation, trade name “MORESCOMELT TY-70”) were charged to mix. And then, the mixture was heated at 110° C., and mixed for 30 minutes to obtain an adhesive composition.

An adhesive sheet was prepared in the same method as described in Example 1, by using the obtained adhesive composition.

By using the obtained adhesive sheet, the above described evaluating tests were conducted. The results are shown in Table 1.

TABLE 1

| | | | | | Comparative |
|---|---|---|---|---|---|
| | | Example | | | Example |
| | | 1 | 2 | 3 | 1 |
| Ingredients of Composition | | | | | |
| Strontium ferrite powder | | 200 | 200 | | 200 |
| Barium ferrite powder | | | | 200 | |
| Polyolefin resin based hot-melt | | 100 | 100 | 100 | — |
| removable adhesive | | | | | |
| Rubber based pressure-sensitive | | — | — | — | 100 |
| adhesive | | | | | |
| Results of evaluation | | | | | |
| Viscosity at 130° C. (Pa · s) | | 80 | 130 | 80 | 110 |
| Magnetic force at room | | 30 | 30 | 23 | 30 |
| temperature before heating (mT) | | | | | |
| Magnetic force at room | | 0 | 0 | 0 | 0 |
| temperature after heating (mT) | | | | | |
| Adhesion | To stainless | 1 | 1 | 1 | 50 |
| (N/25 mm) | steel plate (i) | | | | |
| | To stainless | 17 | 19 | 17 | 100 |
| | steel plate (ii) | | | | |
| | To surface | 11 | 12 | 11 | 40 |
| | smeared with oil | | | | |

| | | | | |
|---|---|---|---|---|
| Solvent resistance | ◯ | ◯ | ◯ | X |
| Gasoline resistance | ◯ | ◯ | ◯ | X |

### Utilization as an Adhesive Sheet for Masking

The removable adhesive sheets obtained in Examples 1 to 3 described above were held on the rail surface of the slide rail (being made of iron) by means of magnetic force at room temperature before coating the peripheral portion around the slide rail of the automobile door. Subsequently, the peripheral portion around the slide rail was coated and baked at 150 for 40 minutes, and then, the removable adhesive sheet was peeled off.

On the rail surface of the slide rail, the coated film was not formed, and the residue (adhesive residue) was not observed. Accordingly, the removable adhesive sheet exerted sufficient function as the adhesive sheet for masking.

The removable adhesive sheet of the present invention can be used as the adhesive sheet for masking various articles exhibiting ferromagnetism. For example, the removable adhesive sheet of the present invention can be used as the adhesive sheet for masking the slide rail of automobile door.

1. A removable adhesive sheet comprising:
a mixture of a hot-melt removable adhesive and a ferromagnetic material.

2. The removable adhesive sheet as claimed in claim 1, wherein the mixture has a viscosity of 5 to 500 Pa·s at 130° C.

3. The removable adhesive sheet as claimed in claim 1, wherein the hot-melt removable adhesive is a polyolefin resin based hot-melt removable adhesive.

4. The removable adhesive sheet as claimed in claim 1, wherein a surface magnetic force is not less than 20 mT and a surface magnetic force, after heating at 150° C. for 40 minutes, is less than 5 mT.

5. The removable adhesive sheet as claimed in claim 4, wherein the removable adhesive sheet is used for masking an article exhibiting ferromagnetism.

6. The removable adhesive sheet as claimed in claim 5, wherein the removable adhesive sheet comprises a masking tape for a slide rail of an automobile.

7. A removable adhesive sheet with a substrate which comprises the removable adhesive sheet as claimed in claim 1 and a substrate, wherein the removable adhesive sheet is laminated on at least one surface of the substrate.

8. The removable adhesive sheet as claimed in claim 2, wherein the hot-melt removable adhesive is a polyolefin resin based hot-melt removable adhesive.

9. The removable adhesive sheet as claimed in claim 2, wherein a surface magnetic force is not less than 20 mT and a surface magnetic force, after heating at 150° C. for 40 minutes, is less than 5 mT.

10. The removable adhesive sheet as claimed in claim 3, wherein a surface magnetic force is not less than 20 mT and a surface magnetic force, after heating at 150° C. for 40 minutes, is less than 5 mT.

11. The removable adhesive sheet as claimed in claim 8, wherein a surface magnetic force is not less than 20 mT and a surface magnetic force, after heating at 150° C. for 40 minutes, is less than 5 mT.

12. The removable adhesive sheet as claimed in claim 9, wherein the removable adhesive sheet is used for masking an article exhibiting ferromagnetism.

13. The removable adhesive sheet as claimed in claim 10, wherein the removable adhesive sheet is used for masking an article exhibiting ferromagnetism.

14. The removable adhesive sheet as claimed in claim 11, wherein the removable adhesive sheet is used for masking an article exhibiting ferromagnetism.

15. The removable adhesive sheet as claimed in claim 12, wherein the removable adhesive sheet comprises a masking tape for a slide rail of an automobile.

16. A removable adhesive sheet with a substrate which comprises the removable adhesive sheet as claimed in claim 2 and a substrate, wherein the removable adhesive sheet is laminated on at least one surface of the substrate.

17. A removable adhesive sheet with a substrate which comprises the removable adhesive sheet as claimed in claim 3 and a substrate, wherein the removable adhesive sheet is laminated on at least one surface of the substrate.

18. A removable adhesive sheet with a substrate which comprises the removable adhesive sheet as claimed in claim 4 and a substrate, wherein the removable adhesive sheet is laminated on at least one surface of the substrate.

19. A removable adhesive sheet with a substrate which comprises the removable adhesive sheet as claimed in claim 5 and a substrate, wherein the removable adhesive sheet is laminated on at least one surface of the substrate.

20. A removable adhesive sheet with a substrate which comprises the removable adhesive sheet as claimed in claim 6 and a substrate, wherein the removable adhesive sheet is laminated on at least one surface of the substrate.
